(19) United States
(12) Patent Application Publication
(10) Pub. No.: US 2017/0291479 A1
(43) Pub. Date: Oct. 12, 2017

(54) MOLDING

(71) Applicant: TOKAI KOGYO CO., LTD., Obu-shi, Aichi (JP)

(72) Inventors: Akito UEDA, Obu-shi (JP); Yosuke KOBAYASHI, Obu-shi (JP)

(73) Assignee: TOKAI KOGYO CO., LTD., Obu-shi, Aichi (JP)

(21) Appl. No.: 15/514,170

(22) PCT Filed: Mar. 11, 2016
(86) PCT No.: PCT/JP2016/057823

§ 371 Date: Mar. 24, 2017

(30) Foreign Application Priority Data
May 1, 2015 (JP) 2015-093883

(51) Int. Cl. B60J 10/75; B60R 13/06; B60J 10/33

(52) U.S. Cl. CPC B60J 10/75; B60J 10/33; B60R 13/06

(57) ABSTRACT

A molding main body including an interior lateral wall portion, an exterior lateral wall portion, and a top wall portion, an engaging portion provided so as to extend from an end portion of the interior lateral wall portion, and a holding lip. When the molding is in a mounting state where the molding is mounted to a flange, a tip end of the holding lip is positioned higher than an upper end of the flange and at the interior side than an exterior side surface of the flange, and the engaging portion is engaged with a lower end of the flange.

### TECHNICAL FIELD

The present invention relates to a molding that is mounted to an edge portion of a door panel of a vehicle. Examples of the molding include an outer belt molding, a beltline molding, and a molding front door beltline outer.

This application claims priority to Japanese Patent Application No. 2015-093883, filed May 1, 2015, the entire content of which is incorporated herein by reference.

### BACKGROUND ART

A long molding is attached to a door of a vehicle such as an automobile, to which a window plate capable of moving up and down is attached. The molding is attached along an upper edge (also referred to as a beltline) of a door panel. The door panel includes an outer panel that constitutes an exterior of the vehicle door and has a curved surface. A flange is provided to an upper edge of the outer panel, and the molding is mounted to the flange. The molding has a substantially U-shaped cross-sectional configuration in which an exterior lateral wall portion disposed on an exterior side of the flange is connected to an interior lateral wall portion disposed on an interior side of the flange by a top portion. For example, Patent Reference 1 discloses technology in the conventional art related to this type of molding.

### PRIOR ART REFERENCE

### Patent Reference

[Patent Reference 1] JP-U-H07-18943

### DISCLOSURE OF THE INVENTION

### Problems that the Invention is to Solve

A beltline molding 1 disclosed in Patent Reference 1 is mounted to a body panel 3 in such a way that a hooking portion 8 provided to a lower end of an interior lateral wall of the beltline molding 1 is hooked onto a bulged portion 9 formed to the body panel 3. The sinking (falling) of the beltline molding 1 from a suitable attachment position is prevented by a projecting surface 12. The projecting surface 12 projects from the inner side of the interior lateral wall of the beltline molding 1.

When mounting the beltline molding 1 disclosed in Patent Reference 1 on the body panel 3, a large force is required to upwardly deform the projecting surface 12. Further, there may be a variation in a length between a portion of the body panel 3 in contact with the projecting surface 12 and a portion of the body panel 3 in contact with the hooking portion 8. If the length is shorter than a predetermined length, the projecting surface 12 does not contact with the body panel 3, and the sinking of the beltline molding cannot be prevented.

The present invention is created to solve the above-described problem, and an object of the present invention is to provide a molding which can be prevented from falling from a suitable attachment position, force required for mounting thereof is not excessively increased, and the mounting state thereof is in a good state even if there is a variation in a length of a flange of a door panel.

### Means for Solving the Problems

The present invention, which is created to solve the above-described problem, provides a long molding which is to be mounted to a flange provided to an edge portion of a door panel of a vehicle. The molding includes a molding main body including an interior lateral wall portion and an exterior lateral wall portion which face each other and an top wall portion which connects the interior lateral wall portion and the exterior lateral wall portion, an engaging portion provided so as to extend from an end portion of the interior lateral wall portion, and a holding lip projecting obliquely upward toward an interior side from an interior side surface of the exterior lateral wall portion. When the molding is in a mounting state where the molding is mounted to the flange, a tip end of the holding lip is positioned higher than an upper end of the flange and at the interior side than an exterior side surface of the flange, and the engaging portion is engaged with a lower end of the flange.

According to the invention disclosed herein, when the molding is in the mounting state, the holding lip is in contact with the upper end of the flange in a state where the tip end of the holding lip is positioned higher than the upper end of the flange and at the interior side than the exterior side surface of the flange. For this reason, even if the molding is further pressed toward the lower side of the flange from a suitable mounting state, the intrusion of the upper end of the flange is stopped by the holding lip, and the flange is suppressed from being moved inward deep inside an inner space of the molding main body. Accordingly, there is an effect that it is possible to prevent the molding from falling downward from the suitable mounting state. When the molding is attached to the flange by applying a downward force to the molding from the upper side of the flange, the holding lip is elastically deformed upward and toward the exterior side, thereby generating reaction force. At this time, the reaction force applied to the flange from the holding lip can be divided into a component toward the interior side and a component toward the lower side. Accordingly, in comparison with a case where the holding lip is deformed only toward the upper side of the flange and reaction force occurs only toward the lower side of the flange, there is an effect that it is possible to prevent an excessive increase in force required to mount the molding.

Further, since the holding lip projects obliquely upward, in a case where the length of the flange is longer than a design value, the holding lip is in contact with the upper end of the flange while being considerably flexed toward an exterior lateral wall portion side, and in a case where the length of the flange is shorter than the design value, the holding lip is in contact with the upper end of the flange while being slightly flexed. Accordingly, there is an effect that even if there is a variation in the length of the flange, the holding lip can be flexed to absorb errors in the length of the flange, and thus the molding can be stably mounted.

A preferred aspect of the molding disclosed herein is characterized in that, in a cross-section, which is perpendicular to the longitudinal direction, of the molding which is not mounted to the flange and is placed in a same posture as that in the mounting state, when a segment connecting a midpoint A and a tip end B is assumed to be a segment AB, an angle α between the segment AB and a horizontal line is greater than 0° and 45° or smaller. Here, when the tip end of the holding lip is assumed to be the tip end B, an upper end of a root of the holding lip is assumed to be an upper end C, a lower end of the root of the holding lip is assumed to be a lower end D, and a midpoint of a segment CD connecting the upper end C and the lower end D is assumed to be the midpoint A.

According to such configuration, in addition to the effect of the invention of claim 1, there is an effect that, since the angle α is greater than 0°, it is possible to prevent an excessive increase in attachment force required to mount the molding to the flange, and since the angle α is 45° or smaller, it is possible to enlarge the reaction force by which the holding lip presses the flange downward when the molding is in the mounting state of being mounted to the flange.

A preferred aspect of the molding disclosed herein is characterized in that, when the molding is in the mounting state, the tip end of the holding lip is positioned at an exterior side than an interior side surface of the flange.

According to such configuration, the length of the holding lip may be set such that the tip end of the holding lip is positioned at the exterior side than the interior side surface of the flange. For this reason, in addition to the above-described effect, there is an effect that it is possible to prevent waste in the material of the holding lip. Further, there is an effect that it is possible to prevent disturbance of an attachment operation caused by contact of the holding lip with the inside of the molding main body when the molding is mounted to the flange.

### BRIEF DESCRIPTION OF DRAWINGS

FIG. 1 is a view illustrating a state in which a molding of an embodiment is mounted to a front door.

FIG. 2A is a cross-sectional view of the molding of the embodiment.

FIG. 2B is an enlarged view of a portion illustrated by X in FIG. 2A.

FIG. 3 is a view illustrating a state in which the molding of the embodiment is being mounted.

FIG. 4 is a view seen in the direction of arrows IV-IV in FIG. 1.

### MODE FOR CARRYING OUT THE INVENTION

Hereinafter, a molding of the present invention will be described in detail based on a preferred embodiment. Items required to realize the present invention, which are items other than items specifically mentioned in this specification (for example, general items and the like related to the manufacturing of a belt molding via an extrusion molding method or the like), can be ascertained as design items by persons skilled in the conventional art. The present invention can be realized based on the items disclosed in this specification and the drawings and common general technical knowledge in the related field.

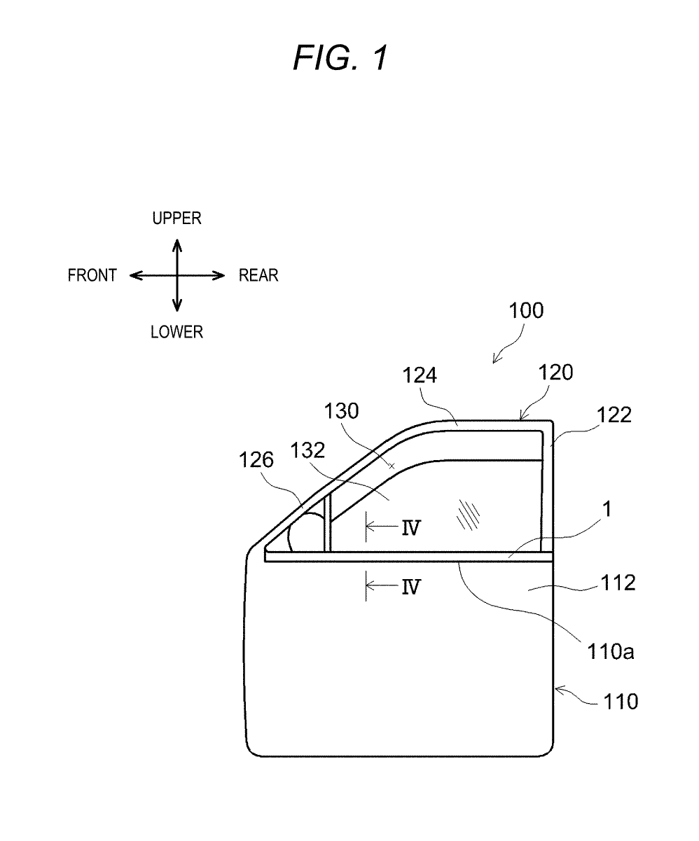

FIG. 1 is a schematic view illustrating a front door 100 of a vehicle, to which a molding 1 of an embodiment is attached. In the example described in the embodiment, the molding 1 is mounted to the front door 100 on the left side of the vehicle. However, technology disclosed herein is not limited to that form. For example, the molding 1 may be mounted to a front door on the right side of the vehicle, and right and left rear doors which are disposed on the rear side of the vehicle, which are not illustrated.

Typically, the front door 100 includes a door panel 110 that constitutes a door main body, and a window frame (door frame) 120 that is formed on the upper side of the door panel 110. The window frame 120 includes a rear vertical portion 122 that is vertically provided along a center pillar of a vehicle which is not illustrated, a horizontal portion 124 that extends along a roof of the vehicle, which is not illustrated, in a front and rear direction of the vehicle and is formed integrally with an upper end portion of the rear vertical portion 122, and an inclined portion 126 that is formed continuously from a front end portion of the horizontal portion 124 and extends obliquely downward from the front end portion along a front pillar of the vehicle which is not illustrated. A window opening portion 130 is formed in such a way as to be surrounded by the rear vertical portion 122, the horizontal portion 124, the inclined portion 126, and an edge portion 110a on the upper side of the door panel 110.

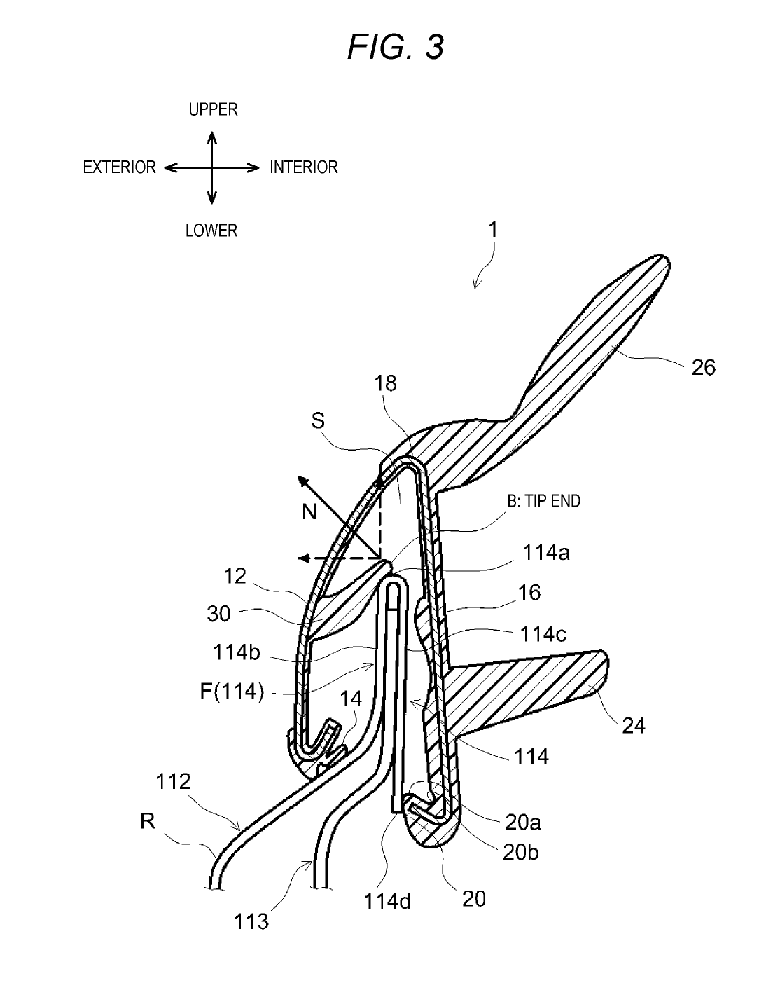

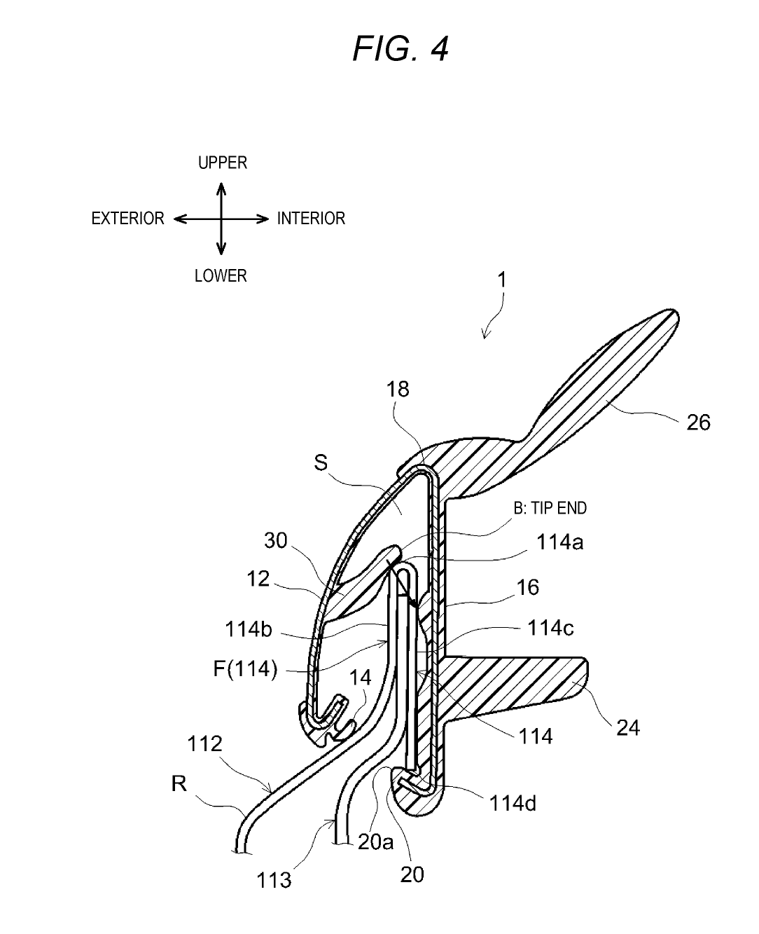

The door panel 110 includes an outer panel 112 that is disposed on an exterior side and constitutes the exterior of the door, and an inner panel 113 (illustrated in FIGS. 3 and 4) that is disposed on an interior side. As illustrated in FIG. 4, typically, the outer panel 112 includes a curved surface portion R that forms the outer shape of the door main body. A flange 114 which is substantially flat is provided at an upper edge (that is, the edge portion 110a of the door panel 110) of the outer panel 112 in such a way that the flange 114 projects upward continuously from the curved surface portion R. The molding 1 disclosed herein is long, and is attached to the flange 114, which is provided to the edge portion 110a of the door panel 110 of the vehicle, in the front and rear direction of the vehicle.

A window plate 132 is attached to the inside of the window opening portion 130 of the door 100. A glass run channel, which is not illustrated, is provided to a window opening portion side lateral surface of each of the inclined portion 126, the horizontal portion 124, and the rear vertical portion 122 which forms the window opening portion 130. A lower side of the window plate 132 is connected to a window plate moving up-and-down mechanism, not shown, that is provided on the inside of the door panel 110, and a peripheral edge of the window plate 132 is fitted to the glass run channel. Accordingly, the window plate 132 is configured such that the window plate 132 is guided by the glass run channels and is moved up and down inside the window opening portion 130.

As illustrated in FIG. 4, the outer panel 112 is formed by pressing a plate-shaped panel into the form of a curved surface. The flange 114 includes a flat portion F that projects substantially vertically upward continuously from the curved surface portion R of the outer panel 112. The flange 114 includes the inner panel 113 that projects upward, and the outer panel 112 that is bent to the interior side and projects downward so that an upper end 114a of the flat portion F of the flange 114 covers the inner panel 113. Here, a length between the upper end 114a of the flange 114 and a lower end 114d of the outer panel 112 is designed so as to become a predetermined dimension. As will be described later, the molding 1 is configured such that an engaging portion 20 of the molding 1 can be engaged with the lower end 114d of the outer panel 112. Here, since the flange 114 is formed by bending a panel, the flange 114 has sufficient strength.

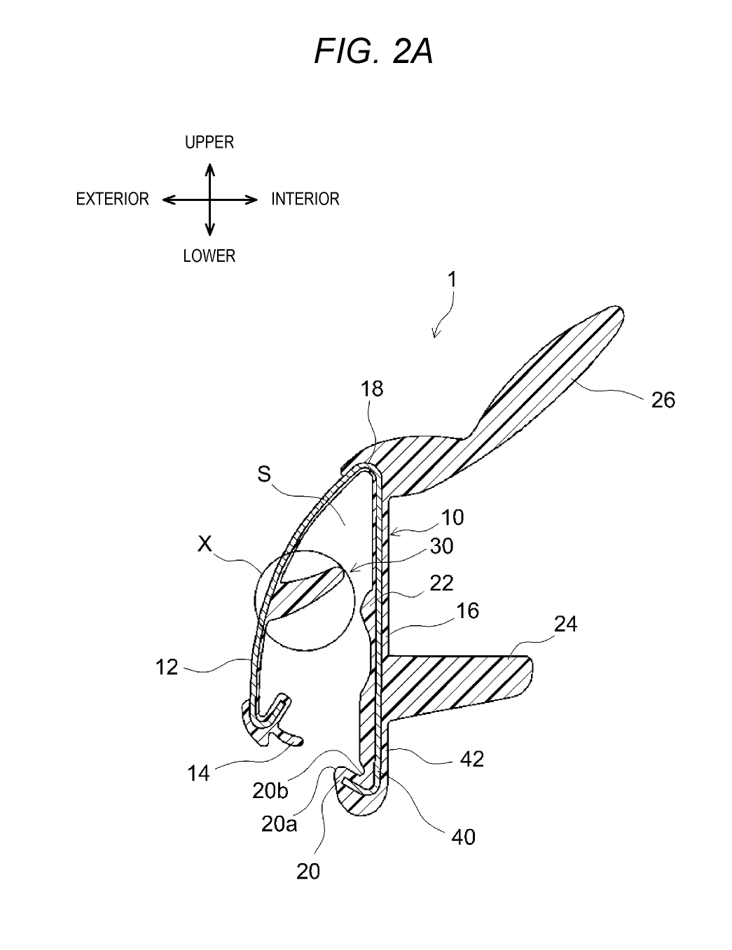

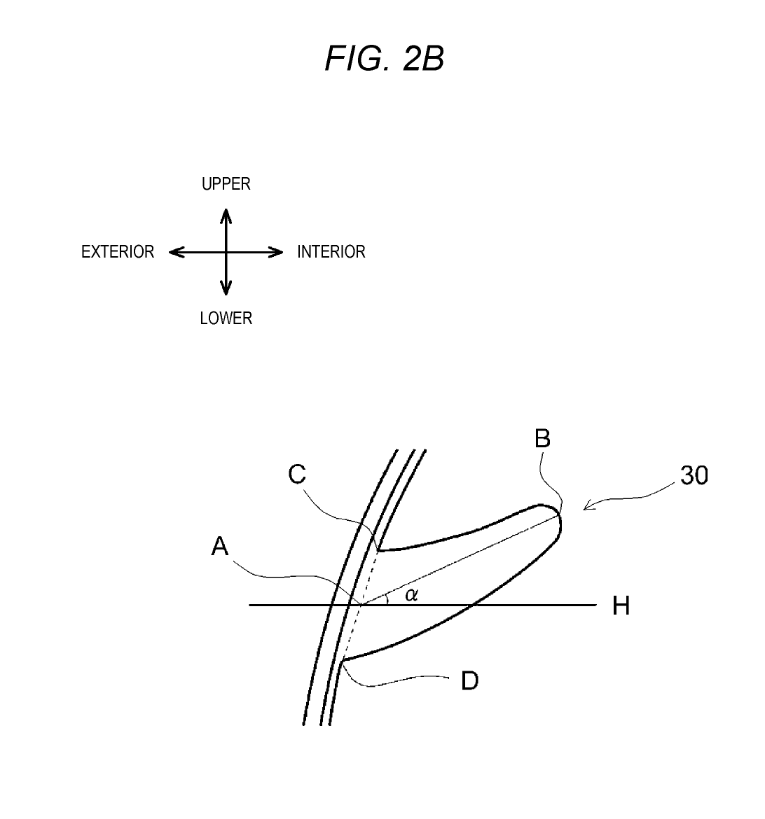

FIG. 2A is a cross-sectional view perpendicular to a longitudinal direction (the front and rear direction of the vehicle) of the molding 1 of the embodiment (hereinafter, simply referred to as a “cross-section”). FIG. 2B is an enlarged view of a portion illustrated by X in FIG. 2A. FIG. 3 is a schematic view illustrating a state in which the molding 1 of the embodiment is being mounted to the door panel. The molding 1 reaches the mounting state illustrated in FIG. 4 via the state shown in FIG. 3. FIG. 4 is a sectional view taken along line IV-IV and seen in the direction of arrows in FIG. 1. FIG. 4 schematically illustrates a state in which the molding 1 of the embodiment is attached to the door panel.

The molding 1 disclosed herein is long in correspondence with the length of the flange 114 in the front and rear direction of the vehicle. As illustrated in FIG. 2A, the molding 1 includes a molding main body 10, the engaging portion 20, and a holding lip 30 as essential configuration elements. The molding main body 10 includes an exterior lateral wall portion 12 and an interior lateral wall portion 16 which face each other, and a top wall portion 18 which connects the exterior lateral wall portion 12 and the interior lateral wall portion 16. The exterior lateral wall portion 12, the top wall portion 18, and the interior lateral wall portion 16 have a substantially U-shaped cross-section. For this reason, an inner space S is formed in the molding main body 10 in such a way that the inner space S is surrounded by the exterior lateral wall portion 12, the top wall portion 18, and the interior lateral wall portion 16.

The exterior lateral wall portion 12 is a portion that is disposed at the exterior side than the flange 114 in a state where the molding 1 is mounted. In the embodiment, an exterior lip 14 is provided at a tip end of the exterior lateral wall portion 12 in such a way that the exterior lip 14 projects from a tip end portion of the exterior lateral wall portion 12 toward the interior side. When the molding 1 is mounted to the flange 114, the exterior lip 14 is in elastic contact with a surface of the outer panel 112, and supports the molding 1.

The interior lateral wall portion 16 is a portion that is disposed at the interior side than the flange 114 in a state where the molding 1 is mounted. In the embodiment, a projecting portion 22 which projects toward the inner space S is provided on an exterior side surface (inner space S side surface) of the interior lateral wall portion 16. The projecting portion 22 has a function of stabilizing the mounting posture of the molding 1 with respect to the flange 114 by being in contact with the flange 114 in the mounting state. An interior seal lip 26 is provided on an interior side surface of the interior lateral wall portion 16 from an upper end of the interior lateral wall portion 16 to the top wall portion 18 along the longitudinal direction of the molding 1. A projecting seal portion 24 is formed slightly below a central portion of the interior side surface of the interior lateral wall portion 16 along the longitudinal direction of the molding 1. The interior seal lip 26 and the projecting seal portion 24 are formed integrally with the molding main body 10 such that, when the molding 1 is mounted to the flange 114, the interior seal lip 26 and the projecting seal portion 24 project from the interior lateral wall portion 16 so as to intersect a surface of the window plate 132 at predetermined angles, and can be in elastic contact with the surface of the window plate 132. A projection length of the projecting seal portion 24 may be, for example, shorter than that of the interior seal lip 26.

The engaging portion 20 is provided so as to extend from an end portion of the interior lateral wall portion 16. A tip end 20a of the engaging portion 20 is formed into a shape in which the tip end 20a is folded obliquely upward toward the exterior side. A recessed portion 20b is formed to the engaging portion 20 due to the folded shape. Due to the recessed portion 20b receiving the lower end 114d of the flange 114, the engaging portion 20 is engaged with the lower end 114d of the flange 114, and the molding 1 is fixed to the door panel.

A core 40 made of metal is provided as a framework in the molding main body 10 and the engaging portion 20 across the exterior lateral wall portion 12, the top wall portion 18, the interior lateral wall portion 16, and the engaging portion 20 in the cross-section. At least a portion of the core 40 is coated with a polymer material 42 having elasticity. In other words, at least a portion of the core 40 is embedded in the polymer material 42. The core 40 is integrally coated with the polymer material 42 such that a portion of the core 40, which has the possibility of being in contact with the flange 114 or the window plate 132 when or in a state where the molding 1 is mounted to the flange 114, is mainly coated with the polymer material 42. Typically, the polymer material 42 is provided on an inner space S side surface of the core 40, the tip end of the exterior lateral wall portion 12 (the exterior lip 14), the engaging portion 20, and the interior side surface of the interior lateral wall portion 16. In a case where the projecting seal portion 24, the interior seal lip 26, and the like are provided, the projecting seal portion 24 and the interior seal lip 26 are formed integrally with the interior lateral wall portion 16 by the polymer material 42 having elasticity. A portion of the core 40 at an exterior side surface of the exterior lateral wall portion 12 may be coated or may not be coated with the polymer material 42.

The holding lip 30 is formed in the inner space S of the molding main body 10 such that the holding lip 30 projects obliquely upward toward the interior side from an interior side surface of the exterior lateral wall portion 12. The holding lip 30 is formed integrally with the exterior lateral wall portion 12 by the polymer material 42 having elasticity. Accordingly, the holding lip 30 can be elastically deformed (flexed) upward and toward the exterior side with respect to the molding main body 10. In the embodiment, the holding lip 30 is tapered from a root (that is, a connection portion between the exterior lateral wall portion 12 and the holding lip 30) toward a tip end B of the holding lip 30. Further, a lower contour of a cross-section of the holding lip 30 is smoothly raised. Here, in a non-mounting state where the molding 1 is not mounted to the flange 114, it is preferable that a distance (dimension) between the tip end of the holding lip 30 and the recessed portion 20b of the engaging portion is equal to or slightly smaller than a length between the upper end 114a and the lower end 114d of the flange 114 (hereinafter, may be simply referred to as the “dimension of the flange 114”).

As illustrated in FIG. 4, when the molding 1 is mounted to the flange 114, the flange 114 is disposed in the inner space S of the molding main body 10. At this time, a mounting direction of the molding 1 is determined such that the exterior lateral wall portion 12 and the interior lateral wall portion 16 are respectively positioned at the exterior side and the interior side than the flange 114. The holding lip 30 is in contact (including elastic contact) with the flange 114. At this time, the tip end B of the holding lip 30 is positioned higher than the upper end 114a of the flange and at the interior side than an exterior side surface 114b of the flange. Further, the engaging portion 20 is engaged with the lower end 114d of the flange 114. Accordingly, the molding 1 is mounted to the flange 114 such that the flange 114 is held by the holding lip 30 and the engaging portion 20 while being interposed therebetween.

Further, as illustrated in FIG. 2A, the holding lip 30 of the molding 1 projects obliquely upward toward the interior side from the exterior lateral wall portion 12. For this reason, the holding lip 30 is flexed in correspondence with the dimension of the flange 114. Specifically, in a case where the dimension of the flange 114 is longer than a predetermined length (design value), the holding lip 30 is in contact with the flange 114 while being considerably flexed toward an exterior lateral wall portion 12 side, and in a case where the dimension of the flange 114 is shorter than the predetermined length, the holding lip 30 is in contact with the flange 114 while being slightly flexed. Accordingly, even if there is a variation in the dimension of the flange 114, the holding lip 30 can be flexed to absorb dimensional errors of the flange 114. Accordingly, the molding 1 can be stably mounted to the flange 114 regardless of the variation in the dimension of the flange 114. It is confirmed that, as an example, if a variation in dimension between the upper end 114a and the lower end 114d of the flange 114 is within approximately ±0.5 cm of the predetermined length, the molding 1 of the embodiment can be stably mounted.

Further, the holding lip 30 is in contact with the flange 114 from an upper side of the exterior side (the exterior lateral wall portion 12). Accordingly, the holding lip 30 can be flexed with force smaller than that in a case where the holding lip 30 projects from the exterior side surface of the interior lateral wall portion 16 and is in contact with the flange 114 from a position substantially right above. Accordingly, it is possible to prevent an excessive increase in force required to flex the holding lip 30.

Further, when the molding 1 is in the mounted state, the holding lip 30 is in contact with the flange 114, and the engaging portion 20 is engaged with the flange 114 at a lower side on the interior side (the interior lateral wall portion 16). Accordingly, in a situation where external force is applied to cause a deviation in relative position between the molding 1 and the flange 114, the holding lip 30 may generate reaction force to press the flange against the engaging portion 20 side. Accordingly, the molding 1 can be more rigidly mounted (fixed) to the flange 114 (the door panel 110). For example, it is possible to realize a configuration in which, even if the vehicle is stopped or is traveling, the molding 1 is unlikely to rattle with respect to the flange 114 (the door panel 110) or to detach from the flange 114.

It is possible to mount the molding 1 to the flange 114 in the following sequence. First, the flange 114, which is provided to the edge portion 110a of the door panel 110, is covered with the molding 1 from the upper side such that the exterior lateral wall portion 12 of the molding main body 10 is positioned at the exterior side than the flange 114 and the interior lateral wall portion 16 is positioned at the interior side than the flange 114. Thereupon, the flange 114 is inserted into the inner space S of the molding 1, and the upper end 114a of the flange 114 is brought into contact with the holding lip 30. Further, the exterior lip 14 at the tip end of the exterior lateral wall portion 12 is brought into contact with the outer panel 112.

At this time, as illustrated in FIG. 3, by applying a downward force to the molding 1 to press the molding 1 downward, the holding lip 30 is flexed upward and toward the exterior side by the upper end 114a of the flange. Thereupon, the flange 114 is moved inward in the inner space S by the amount of flex of the holding lip 30. Further, the lower end 114d of the flange climbs over the tip end 20a of the engaging portion to be engaged with the engaging portion 20 (the recessed portion 20b). Accordingly, the upper end 114a of the flange is in contact with the vicinity of the tip end B of the holding lip 30, thereby realizing the above-described mounting state.

During the mounting of the molding 1, it is necessary to press the molding 1 with a force larger than a reaction force from the holding lip 30. According to the above-described configuration, when engagement between the lower end 114d of the flange and the engaging portion 20 is completed, the reaction force is released, and it is possible to feel a feeling of release (so-called click feeling).

In a molding in the conventional art, if a force to press the molding downward is excessive or a downward force is applied to the molding after being mounted, there may be a problem that the upper end 114a of the flange is moved inward in the inner space S, and the molding may fall downward from a suitable mounting state. In contrast, in the molding 1 disclosed herein, excessive intrusion of the flange 114 into the inner space S can be prevented by the reaction force of the holding lip 30. Accordingly, even if excessive force is applied to the molding 1 when being mounted or after being mounted, it is possible to prevent the falling of the molding 1.

In a more preferable embodiment, the shape of the holding lip 30 may have the following configuration. That is, as illustrated in FIG. 2B, in the cross-section of the molding 1 which is not mounted to the flange 114 but is placed in a same posture as that in the mounting state, a tip end of the holding lip 30 is assumed to be a tip end B. Further, an upper end of a root of the holding lip 30 is assumed to be an upper end C, and a lower end of the root is assumed to be a lower end D on the interior side surface of the exterior lateral wall portion 12. Further, a midpoint of a segment CD connecting the upper end C and the lower end D is assumed to be a midpoint A, and a segment connecting the midpoint A and the tip end B is assumed to be a segment AB. An inclination of the holding lip 30 which projects obliquely upward toward the interior side from the exterior lateral wall portion 12 can be represented by an angle α formed between the segment AB and a horizontal line H. The angle α is measured as a positive angle which is formed in an upward direction with respect to the horizontal line H (counterclockwise direction in FIG. 2B), or a negative angle which is formed in a downward direction with respect to the horizontal line H (clockwise direction in FIG. 2B). It can be considered that the holding lip 30 is flexed upward toward the exterior side substantially around the midpoint A.

According to the technology disclosed herein, the angle α preferably is greater than 0° and 45° or smaller. The reason for this is as follows. When the molding 1 is attached to the flange 114 by applying a downward force to the molding 1 from the upper side of the flange 114, if the holding lip 30 is flexed upward and toward the exterior side by the upper end 114a of the flange, as illustrated in FIG. 3, a force N obliquely upward toward the exterior side is applied to the holding lip 30 from the flange 114. The force N can be divided into a component toward the upper side and a component toward the exterior side. At the same time, reaction force (elastic reaction force, see FIG. 4) is applied to the flange 114 from the holding lip 30 such that the reaction force is balanced with the force N. The reaction force can be divided into a component toward the lower side and a component toward the interior side such that the reaction force is balanced with the force N. In this case, by setting the angle α to be greater than 0°, it is possible to prevent an excessive increase in force required to flex the holding lip 30 in comparison with that in a case where the holding lip 30 projects horizontally and only an upward force is applied to the holding lip 30 from the flange 114 (case where the angle α is 0°) or in a case where the holding lip 30 projects downward (case where the angle α is smaller than) 0°). If the angle α exceeds 45°, since a ratio of contribution of the component toward the lower side of the reaction force of the holding lip 30 in the mounting state becomes too small, the reaction force dissipates toward the interior side. Accordingly, the angle α is preferably set to 45° or smaller so as to be able to effectively ensure a downward force of the holding lip 30 which presses the upper end 114a of the flange from the upper side.

Here, when the molding 1 disclosed herein is in the mounting state, the holding lip 30 may be in contact with the upper end 114a of the flange at the vicinity of the tip end B. At this time, it is preferable that the tip end B of the holding lip 30 is positioned at the interior side than the exterior side surface 114b of the flange and at the exterior side than an interior side surface 114c. If the holding lip 30 has such a length, it is possible to obtain effects of the present invention. For this reason, it is not necessary for the holding lip 30 to have an excessive length, and it is possible to prevent waste in the material for forming the holding lip 30. Further, it is possible to prevent disturbance of an attachment operation caused by contact of the holding lip 30 with the inside of the molding main body 10 when the molding 1 is mounted to the flange 114. Here, the tip end B of the holding lip 30 when the molding 1 is not mounted but is placed in the same posture at that in the mounting state is positioned lower than the upper end 114a of the flange in a suitable mounting state. Further, as is obvious, the upper end C and the lower end D of the holding lip 30 are positioned lower than the upper end 114a of the flange in the suitable mounting state.

In the above-described molding 1, metal which can be used as the material of the core 40 is not specifically limited. For example, it is possible to use various metals such as steel, steel alloys (typically, various stainless steels), aluminum, and aluminum alloys.

Further, the polymer material 42 with which the core 40 is covered is not specifically limited insofar as the polymer material 42 has suitable elasticity and rigidity. For example, it is possible to use polymer materials such as various thermoplastic resins, rubbers, and thermoplastic elastomers.

Examples of the thermoplastic resin include polyolefin-based resins such as polyethylene and polypropylene; styrene-based resins such as polystyrene and acrylonitrile-butadiene-styrene copolymer resin (ABS resin); acrylic resin; vinyl chloride resin; and acrylonitrile-ethylene/propylene rubber-styrene copolymer resin (AES resin).

Examples of the rubber include natural rubber (NR); and various synthetic rubbers such as acrylic rubber (ACM), ethylene-acrylic rubber, butyl rubber (IIR), ethylene-propylene rubber (EPM), ethylene-propylene-diene rubber (EPDM), fluororubber, chloroprene rubber (CR), nitrile rubber (NBR), butadiene rubber (BR), isoprene rubber (IR), a styrene-butadiene rubber (SBR), chlorosulfonated polyethylene (CSM), chlorinated polyethylene rubber (CPE), and silicone rubber.

Examples of various thermoplastic elastomer include styrene-based, olefin-based, ester-based, polyamide-based, vinyl chloride-based, and urethane-based thermoplastic elastomers. As an example, the durometer hardness of the polymer materials measured according to JIS K7215:1986 preferably is approximately HDA 55 to HDA 85.

The polymer material 42 of the holding lip 30 may be the same as or different from the polymer material 42 used for the molding main body 10.

In the embodiment, stainless steel is used as the material of the core 40, and vinyl chloride resin having a durometer hardness of HDA 65 is used as the polymer material 42.

A specific example of the present invention has been described in detail with reference to the accompanying drawings. However, the specific example is merely an example, and does not limit the claims. Technology described in the claims include various modifications and changes of the above-described specific example.

### REFERENCE SIGNS LIST

1: MOLDING

10: MOLDING MAIN BODY

12: EXTERIOR LATERAL WALL PORTION

14: EXTERIOR LIP

16: INTERIOR LATERAL WALL PORTION

18: TOP WALL PORTION

20: ENGAGING PORTION

20a: TIP END

20b: RECESSED PORTION

30: HOLDING LIP

40: CORE

42: POLYMER MATERIAL

A: MIDPOINT

B: TIP END

C: UPPER END

D: LOWER END

1. A long molding which is to be mounted to a flange provided to an edge portion of a door panel of a vehicle, the molding comprising:
a molding main body including an interior lateral wall portion and an exterior lateral wall portion which face each other and an top wall portion which connects the interior lateral wall portion and the exterior lateral wall portion;
an engaging portion provided so as to extend from an end portion of the interior lateral wall portion; and
a holding lip projecting obliquely upward toward an interior side from an interior side surface of the exterior lateral wall portion,
wherein, when the molding is in a mounting state where the molding is mounted to the flange,
a tip end of the holding lip is positioned higher than an upper end of the flange and at the interior side than an exterior side surface of the flange, and
the engaging portion is engaged with a lower end of the flange.

2. The molding according to claim 1,
wherein, in a cross-section, which is perpendicular to a longitudinal direction, of the molding which is not mounted to the flange and is placed in a same posture as that in the mounting state, when the tip end of the holding lip is assumed to be a tip end B, an upper end of a root of the holding lip is assumed to be an upper end C, a lower end of the root of the holding lip is assumed to be a lower end D, a midpoint of a segment CD connecting the upper end C and the lower end D is assumed to be a midpoint A, and a segment connecting the midpoint A and the tip end B is assumed to be a segment AB, an angle α between the segment AB and a horizontal line is greater than 0° and 45° or smaller.

3. The molding according to claim 2,
wherein, when the molding is in the mounting state,
the tip end of the holding lip is positioned at an exterior side than an interior side surface of the flange.

4. The molding according to claim 1,
wherein, when the molding is in the mounting state,
the tip end of the holding lip is positioned at an exterior side than an interior side surface of the flange.
